(19) United States
(12) Patent Application Publication
(10) Pub. No.: US 2015/0253493 A1
(43) Pub. Date: Sep. 10, 2015

(54) DISPLAY DEVICE

(71) Applicant: InnoLux Corporation, Miao-Li County (TW)

(72) Inventors: Chin-Tu TSAI, Miao-Li County (TW); Chi-Hsiang CHIANG, Miao-Li County (TW); Tsung-Sheng TANG, Miao-Li County (TW); Ting-Wei LIN, Miao-Li County (TW)

(21) Appl. No.: 14/633,767

(22) Filed: Feb. 27, 2015

(30) Foreign Application Priority Data
Mar. 5, 2014 (TW) 103203760

(51) Int. Cl. F21V 8/00; G02F 1/1333

(52) U.S. Cl. CPC G02B 6/0045; G02B 6/009; G02F 1/133308; G02F 2001/13332; G02F 2001/133314

(57) ABSTRACT

A display device includes a display panel and a backlight module. The backlight module is disposed opposite the display panel and includes a light guiding unit and at least a light emitting unit. The light guiding unit has at least a light input surface and a light output surface facing the display panel. The light output surface and the light input surface share a curved first side. The light emitting unit includes a plurality of light emitting elements disposed adjacent to the light input surface.

### CROSS REFERENCE TO RELATED APPLICATIONS

This Non-provisional application claims priority under 35 U.S.C. §119(a) on Patent Application No(s). 103203760 filed in Taiwan, Republic of China on Mar. 5, 2014, the entire contents of which are hereby incorporated by reference.

### BACKGROUND OF THE INVENTION

1. Field of Invention

The invention relates to a curved display device.

2. Related Art

Flat display devices, having advantages such as low power consumption, less heat, light weight and non-radiation, are widely applied to various electronic products and gradually take the place of cathode ray tube (CRT) display devices.

A conventional liquid crystal display (LCD) device includes an LCD panel and a backlight module disposed opposite the LCD panel. The LCD panel includes a plurality of pixel disposed in an array. The backlight module can emit the light passing through the LCD panel, and then the pixels of the LCD panel can display colors to form images.

With the raised requirements from different consumers, a lot of companies unceasingly develop novel flat display devices to satisfy these requirements. So, the concept of a curved display device has been presented in the industry. Generally, when a curved display device displays an image, the distances from different positions on the image to the viewer's eye are fairly equal to each other, so the viewer can obtain a full view angle vision with a better surrounding feeling.

### SUMMARY OF THE INVENTION

An objective of the invention is to provide a curved display device so as to satisfy different requirements from different consumers.

To achieve the above objective, a display device according to the invention includes a display panel and a backlight module. The backlight module is disposed opposite the display panel and includes a light guiding unit and at least a light emitting unit. The light guiding unit has at least a light input surface and a light output surface facing the display panel. The light output surface and the light input surface share a curved first side. The light emitting unit includes a plurality of light emitting elements disposed adjacent to the light input surface.

In one embodiment, a curve line passes through the light emitting elements and a curving degree of the curve line is substantially the same as that of the first side.

In one embodiment, the display panel has a second side corresponding to the first side, and the curvature radius of the first side, second side or curve line is between 500 mm and 10000 mm.

In one embodiment, the curvature radius of the first side, second side or curve line is further between 2000 mm and 7500 mm.

In one embodiment, the display panel further has a display surface, which is a concave surface or a convex surface.

In one embodiment, the light emitting unit further includes a circuit board, the light emitting elements are disposed on the circuit board, the circuit board has a third side, and a curving degree of the third side is matched with that of the first side.

In one embodiment, the circuit board has a surface for the disposition of the light emitting elements, and the surface faces the light input surface.

In one embodiment, the circuit board has a surface for the disposition of the light emitting elements, and the extension of the surface is substantially parallel to the light output surface.

In one embodiment, the light guiding unit further has a bottom surface that is opposite the light output surface, and the bottom surface contacts the surface.

In one embodiment, the display device further comprises a back plate and a front frame element. The back plate accommodates the backlight module. The front frame element is connected with the back plate to form an accommodating space in which the display panel and the backlight module are disposed.

In one embodiment, the curving degrees of the display panel, backlight module, back plate and front frame element are matched with each other.

As mentioned above, in the display device of the invention, the backlight module is disposed opposite the display panel and includes a light guiding unit and at least a light emitting unit. The light guiding unit has at least a light input surface and a light output surface facing the display panel. The light output surface and the light input surface share a curved first side. The light emitting unit includes a plurality of light emitting elements disposed adjacent to the light input surface. Thereby, the display device of the invention is different from the conventional art and can satisfy different requirements from different consumers.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic diagram of a display device of an embodiment of the invention;

FIG. 1B is a schematic exploded diagram of the display device in FIG. 1A;

FIGS. 1C and 1D are schematic side-view and sectional diagrams of the backlight module in FIG. 1B, respectively;

FIG. 2A is a schematic diagram of a display device of another embodiment of the invention;

FIG. 2B is a schematic diagram of the backlight module of the display device in FIG. 2A;

FIGS. 3A and 3B are schematic side-view and sectional diagrams of a backlight module of another embodiment of the invention, respectively; and

FIG. 4 is a schematic side-view diagram of a backlight module of another embodiment of the invention.

### DETAILED DESCRIPTION OF THE INVENTION

The present invention will be apparent from the following detailed description, which proceeds with reference to the accompanying drawings, wherein the same references relate to the same elements.

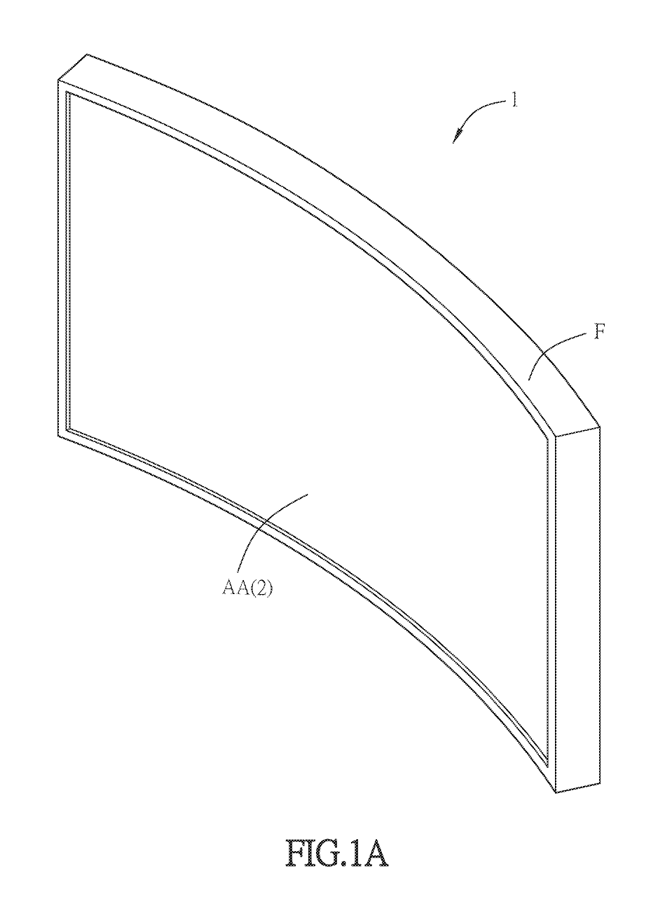

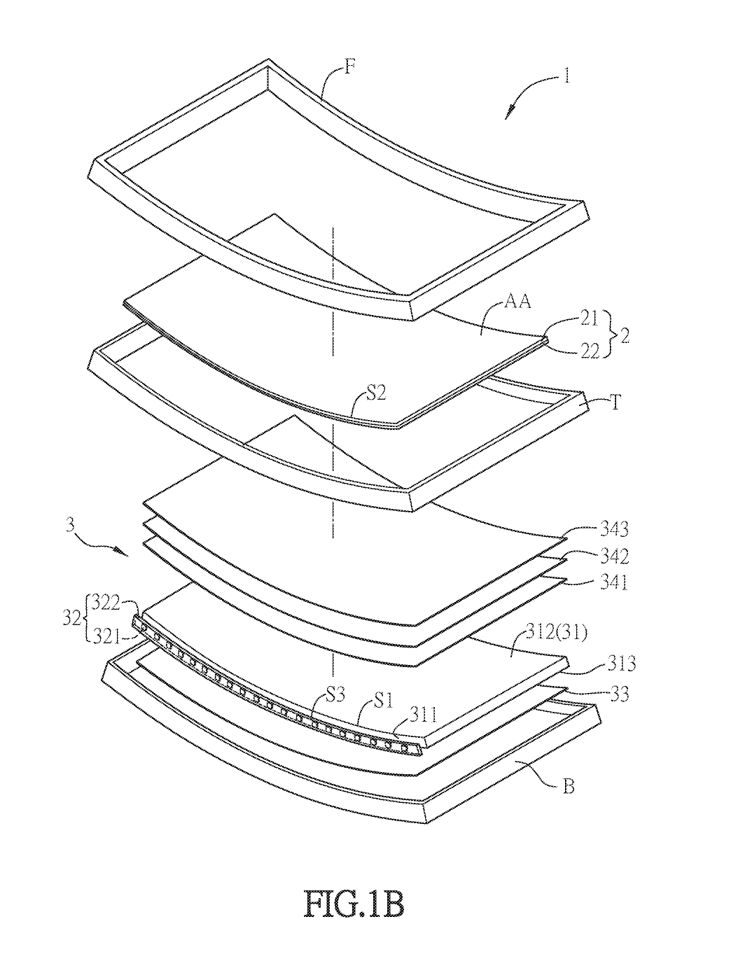

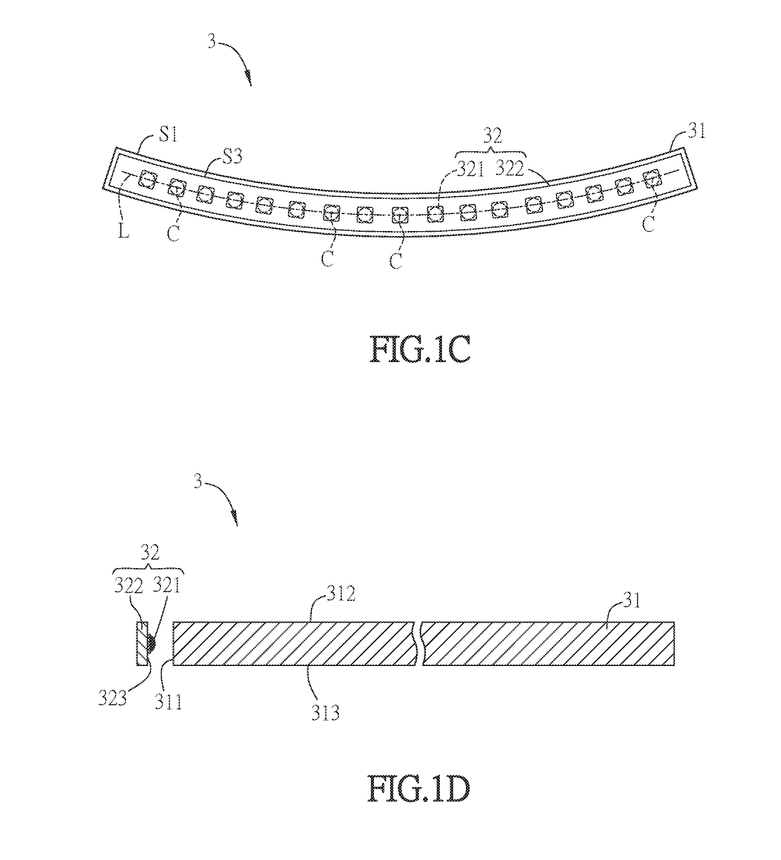

FIG. 1A is a schematic diagram of a display device 1 of an embodiment of the invention, FIG. 1B is a schematic exploded diagram of the display device 1 in FIG. 1A, and FIGS. 1C and 1D are schematic side-view and sectional diagrams of the backlight module 3 in FIG. 1B, respectively.

The display device 1 includes a display panel 2 and a backlight module 3.

The display panel 2 is a liquid crystal display (LCD) panel for example and has a display surface AA, which is a concave surface or a convex surface. Herein, the so-called concave surface indicates that the opposite sides of the display panel are protruded more than the central portion while the convex surface indicates that the central portion of the display panel is protruded more than the opposite sides. In this embodiment, the display surface AA of the display panel 2 is a concave surface for example.

The display panel 2 includes a first substrate 21 and a second substrate 22, and the first substrate 21 is disposed opposite the second substrate 22. Herein for example, the first substrate 21 is a color filter (CF) substrate and the second substrate 22 is a thin film transistor (TFT) substrate. In other embodiments, however, the black matrix or the filter layer of the CF substrate can be disposed to the TFT substrate, so that the second substrate 22 becomes a BOA (BM on array) substrate or a COA (color filter on array) substrate. Moreover, the display panel 2 can further include an upper polarizer and a lower polarizer (not shown), and the upper polarizer is attached to the upper surface of the first substrate 21 while the lower polarizer is attached to the lower surface of the second substrate 22. Besides, the display panel 2 can further include a liquid crystal layer (not shown), which is disposed between the first and second substrates 21 and 22. Since the display surface AA of the display panel 2 is a concave surface, it indicates that the display panel 2 is a curved panel and even the first substrate 21, the second substrate 22, the liquid crystal layer, the upper polarizer and the lower polarizer substantially have the same curving degree.

The backlight module 3 is disposed opposite the display panel 2. The backlight module 3 can emit the light to the display panel 2 so that the display panel 2 can display images. The backlight module 3 includes a light guiding unit 31 and at least a light emitting unit 32. The light guiding unit 31 has at least a light input surface 311, a light output surface 312 and a bottom surface 313 disposed opposite the light output surface 312. The light input surface 311 and the light output surface 312 are adjacent surfaces. The light output surface 312 faces the display panel 2. The light output surface 312 and the light input surface 311 share a curved first side S1. In other words, the backlight module 3 of this embodiment is a side-light type and also a curved backlight module. The light guiding unit 31 can be made by transparent material, such as poly(l-carboxyethylene), polycarbonate, polyethylene or glass.

The light emitting unit 32 is a light bar and includes a plurality of light emitting elements 321 disposed adjacent to the light input surface 311, and the light emitted by the light emitting elements 321 enters the light guiding unit 31 through the light input surface 311 and is outputted through the light output surface 312. Moreover, the light emitting unit 32 further includes a circuit board 322 (such as MCPCB/PCBA), and the light emitting elements 321 are disposed on the circuit board 322. The circuit board 322 is a curved circuit board. In this embodiment, a single light emitting unit 32 is disposed corresponding to a single light input surface 311 for example. In other embodiments, however, another light emitting unit 32 can be disposed to another surface (another light input surface) that is opposite the light input surface 311 of the light emitting unit 31. In this embodiment, as shown in FIG. 1D, the circuit board 322 has a surface 323 for the disposition of the light emitting elements 321, and the surface 323 of the circuit board 322 faces the light input surface 311 (i.e. the top view LEDs).

A curve line L can pass through the light emitting elements 321, and the curving degree of the curve line L is substantially equal to that of the first side S1 of the light guiding unit 31. In this embodiment, as shown in FIG. 1C, the curve line L passes through the centroids C of the light emitting elements 321. Herein, the centroid C denotes the center of the geometric figure of the light emitting element 321. In other words, a curve ling L will pass through the center of the geometric figure of each of the light emitting elements 321, so that the light emitting elements 321 have the arrangement according to a curve line, and therefore the curve line L passing through the all centroids C will have a curving degree substantially the same as (or regarded as matched with) the curving degree of the first side S1.

As shown in FIG. 1B, since the first side S1 is a curved side, the display panel 2 also has a second side S2 corresponding to the first side S1, and the curvature radius of the first side S1 of the light guiding unit 31, second side S2 of the display panel 2, or curve line L passing through the centroids C of the all light emitting elements 321 can be between 500 mm and 10000 mm (500 mm≦curvature radius≦10000 mm) Favorably, the curvature radius of the first side S1, second side S2 or curve line L can be further between 2000 mm and 7500 mm (2000 mm≦curvature radius≦7500 mm) The first side S1, the second side S2 and the curve line L have the same curving degree (can have substantially the same radian). Moreover, the circuit board 322 also has a third side S3, and the curving degree of the third side S3 is substantially the same as that of the first side S1. Herein, the relation among the curvature radiuses of the first side S1, second side S2, third side S3 and curve line L is as follows: the second side S2<the first side S1<the third side S3<the curve line L.

The backlight module 3 can further include a reflective plate 33 and a plurality of optical films 341, 342, 343. The reflective plate 33 is disposed at the bottom surface 313, and the optical films 341, 342, 343 are disposed between the light output surface 312 of the light guiding unit 31 and the display panel 2. The optical films 341, 342, 343 can include a light concentration sheet or a diffusion sheet for example, but this invention is not limited thereto. Since the reflective plate 33 and the optical films 341, 342, 343 of the backlight module 3 belong to the conventional art, they can be comprehended by those in the skilled art and therefore are not described here for conciseness.

The display device 1 can further include a back plate B, a plastic frame T and a front frame element F. The back plate B can accommodate the backlight module 3. The plastic frame T is disposed on the back plate B for holding the display panel 2. The front frame element F and the back plate B are connected to each other to form an accommodating space so that the display panel 2 and the backlight module 3 can be accommodated in the accommodating space. In this embodiment, as shown in FIG. 1B, the optical films 341, 342, 343 are disposed on the lower side of the plastic frame T. In other embodiments, however, the optical films 341, 342, 343 can be disposed on the upper side of the plastic frame T.

Since the display device 1 is a curved display device, the curving degrees of the above-mentioned display panel 2, backlight module 3, back plate B, plastic frame T and front frame element F are matched with each other, and that means the curving degrees of these elements are substantially the same. To be noted, in the actual manufacturing process of the display device 1, a one-piece or multi-piece inflexible curved rack (the curved rack has been curved into a fixed shape, not shown) can be used to force the display device to be curved into a particular curving degree. The back plate B can be, for example, screwed to the curved rack so as to have the same curving degree as the curved rack. Then, the flexible reflective plate BB, light guiding unit 31 and optical films 341, 342, 343 are attached to the curved back plate B so as to be curved as the curving degree of the back plate B. Besides, the light emitting unit 32 that has the same curving degree as the first side S1 of the light guiding unit 31 is disposed adjacent to the light input surface 311 of the light guiding unit 31. Then, the plastic frame T and the display panel 2 are curved with the curving degree of the backlight module 3 and back plate B, and the front frame element F is designed as a curved shape and connected to the back plate B, and therefore the display device 1 is fixed at a curved state.

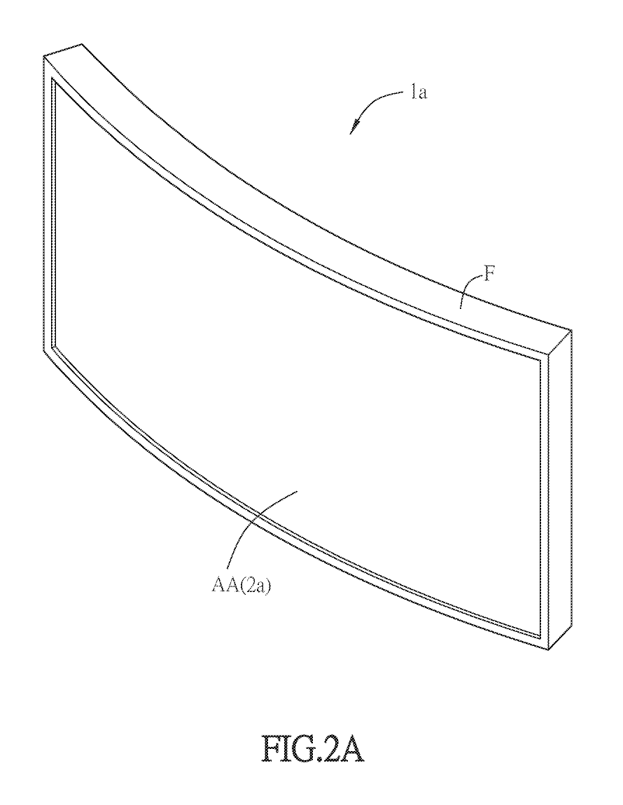

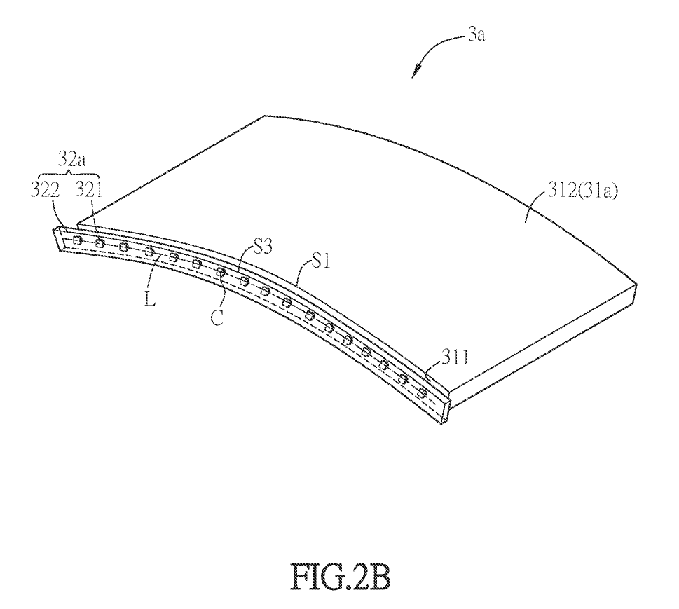

FIG. 2A is a schematic diagram of a display device 1a of another embodiment of the invention, and FIG. 2B is a schematic diagram of the backlight module 3a of the display device 1a in FIG. 2A.

The main difference between the display device 1a in FIG. 2A and the display device 1 in FIG. 1A is that the display surface AA of the display device 1a is a convex surface. In other words, the central portion of the display panel 2a of the display device 1a is protruded more than the opposite sides. Accordingly, as shown in FIG. 2B, the central portion of the light guiding unit 31a of the backlight module 3a is also protruded more than the opposite sides. However, the curve line L still can pass through the centroids C of the all light emitting elements 321 of the light emitting unit 32a, and the curving degree of the curve line L is also substantially the same as that of the first side S1 of the light guiding unit 31. Moreover, the curving degree of the third side S3 of the circuit board 322 of the light emitting unit 32a is also substantially the same as that of the first side S1.

Since other technical features of the display device 1a can be comprehended by referring to the display device 1, they are omitted here for conciseness.

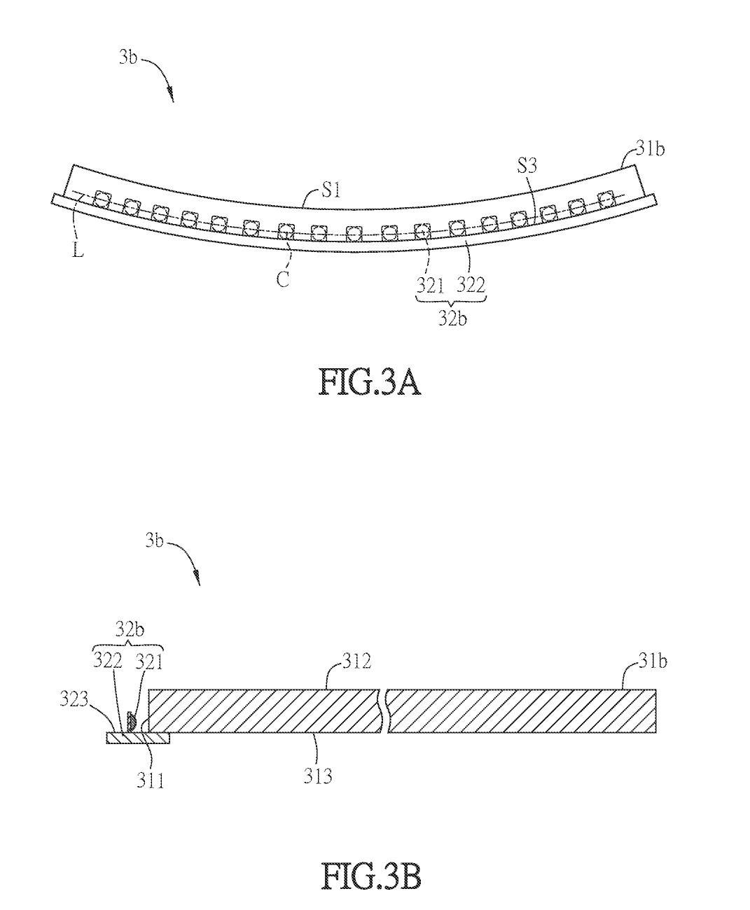

FIGS. 3A and 3B are schematic side-view and sectional diagrams of a backlight module 3b of another embodiment of the invention, respectively.

The main difference between the backlight module 3b in FIGS. 3A and 3B and the backlight module 3 in FIGS. 1C and 1D is illustrated as below. The circuit board 322 of the light emitting unit 32b of the backlight module 3b also has a surface 323 for the disposition of the light emitting elements 321, but the extension of the surface 323 is substantially parallel to the light output surface 312 instead of facing the light input surface 311, so that the light emitting element 321 is a side view LED. The surface 323 of the circuit board 322 of the light emitting unit 32b contacts the bottom surface 313 of the light guiding unit 31b.

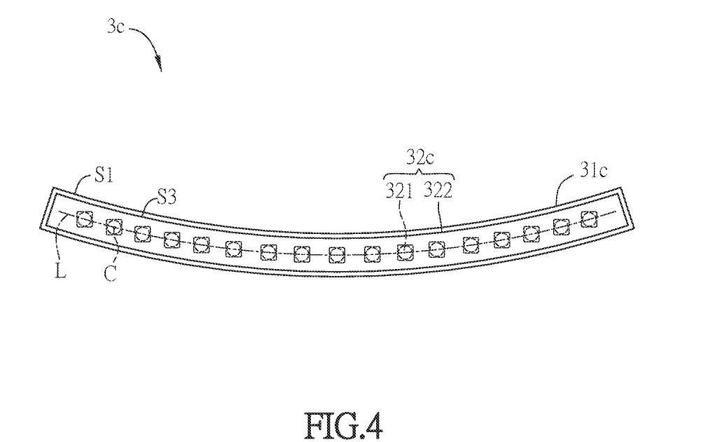

FIG. 4 is a schematic side-view diagram of a backlight module 3c of another embodiment of the invention.

As shown in FIG. 4, the main difference between the backlight module 3c in FIG. 4 and the backlight module 3 in FIG. 1C is illustrated as below. Although the light emitting elements 321 of the light emitting unit 32c are arranged into a curved shape like the light emitting elements 321 of the light emitting unit 32, every light emitting element 321 of the light emitting unit 32c is not disposed obliquely with the first side S1 but vertically on the circuit board 322 of the light emitting unit 32c. Besides, the curve line L still can pass through the centroids C of the all light emitting elements 321 of the light emitting unit 32c, and the curving degree of the curve line L is also substantially the same as (matched with) that of the first side S1 of the light guiding unit 31c. Moreover, the curving degree of the third side S3 of the circuit board 322 of the light emitting unit 32c is also substantially the same as that of the first side S1.

Since other technical features of the backlight modules 3a, 3b can be comprehended by referring to the backlight module 3, they are omitted here for conciseness.

Summarily, in the display device of the invention, the backlight module is disposed opposite the display panel and includes a light guiding unit and at least a light emitting unit. The light guiding unit has at least a light input surface and a light output surface facing the display panel. The light output surface and the light input surface share a curved first side. The light emitting unit includes a plurality of light emitting elements disposed adjacent to the light input surface. Thereby, the display device of the invention is different from the conventional art and can satisfy different requirements from different consumers.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display device, comprising:
a display panel; and
a backlight module disposed opposite the display panel and including a light guiding unit and at least a light emitting unit, wherein the light guiding unit has at least a light input surface and a light output surface facing the display panel, the light output surface and the light input surface share a curved first side, and the light emitting unit includes a plurality of light emitting elements disposed adjacent to the light input surface.

2. The display device as recited in claim 1, wherein a curve line passes through the light emitting elements and a curving degree of the curve line is substantially the same as that of the first side.

3. The display device as recited in claim 1, wherein the display panel has a second side corresponding to the first side, and the curvature radius of the first side, second side or curve line is between 500 mm and 10000 mm.

4. The display device as recited in claim 1, wherein the display panel further has a display surface, which is a concave surface or a convex surface.

5. The display device as recited in claim 1, wherein the light emitting unit further includes a circuit board, the light emitting elements are disposed on the circuit board, the circuit board has a third side, and a curving degree of the third side is matched with that of the first side.

6. The display device as recited in claim 5, wherein the circuit board has a surface for the disposition of the light emitting elements, and the surface faces the light input surface.

7. The display device as recited in claim 5, wherein the circuit board has a surface for the disposition of the light emitting elements, and the extension of the surface is substantially parallel to the light output surface.

8. The display device as recited in claim 7, wherein the light guiding unit further has a bottom surface that is opposite the light output surface, and the bottom surface contacts the surface.

9. The display device as recited in claim 1, further comprising:
a back plate accommodating the backlight module; and
a front frame element connected with the back plate to form an accommodating space in which the display panel and the backlight module are disposed.

10. The display device as recited in claim 9, wherein the curving degrees of the display panel, backlight module, back plate and front frame element are matched with each other.
